(19) United States
(12) Patent Application Publication
(10) Pub. No.: US 2016/0204414 A1
(43) Pub. Date: Jul. 14, 2016

(54) POSITIVE ELECTRODE ACTIVE MATERIAL FOR NONAQUEOUS ELECTROLYTE SECONDARY BATTERIES AND NONAQUEOUS ELECTROLYTE SECONDARY BATTERY USING THE SAME

(71) Applicant: SANYO ELECTRIC CO., LTD., Daito-shi, Osaka (JP)

(72) Inventors: Manabu Takijiri, Hyogo (JP); Katsunori Yanagida, Hyogo (JP); Takeshi Ogasawara, Hyogo (JP); Kaoru Nagata, Osaka (JP)

(73) Assignee: SANYO ELECTRIC CO., LTD., Daito-shi, Osaka (JP)

(21) Appl. No.: 14/910,359

(22) PCT Filed: Sep. 18, 2014
(86) PCT No.: PCT/JP2014/004812

§ 371 Date: Feb. 5, 2016

(30) Foreign Application Priority Data
Sep. 30, 2013 (JP) 2013-203347

(51) Int. Cl. H01M 4/131; H01M 4/525; H01M 4/62; H01M 10/0525

(52) U.S. Cl. CPC H01M 4/131; H01M 10/0525; H01M 4/525; H01M 4/62; H01M 2004/028

(57) ABSTRACT

Provided are a positive electrode active material, capable of achieving both high capacity and high output, for nonaqueous electrolyte secondary batteries and a nonaqueous electrolyte secondary battery using the same. A positive electrode active material for nonaqueous electrolyte secondary batteries according to the present invention contains a lithium transition metal oxide which has a layered structure and which contains Ni as a transition metal. The percentage of Ni element with respect to the total molar amount of metal elements, other than lithium, in the lithium transition metal oxide is 89 mole percent or more. A zirconium compound is present on the surface of the lithium transition metal oxide.

### TECHNICAL FIELD

An embodiment of the present invention relates to a positive electrode active material for nonaqueous electrolyte secondary batteries and a nonaqueous electrolyte secondary battery using the same.

### BACKGROUND ART

In recent years, smaller and lighter mobile data terminals such as mobile phones, notebook personal computers, and smartphones have been increasingly used and batteries used as driving power supplies therefor have been required to have higher capacity. Nonaqueous electrolyte secondary batteries, which are charged and discharged in such a manner that lithium ions move between positive and negative electrodes in association with charge and discharge, have high energy density and high capacity and therefore are widely used as driving power supplies for the above mobile data terminals.

Furthermore, the nonaqueous electrolyte secondary batteries are recently attracting attention as power supplies for electric tools, electric vehicles, and the like and applications thereof are expected to be further expanded. Such power supplies need to have both high capacity so as to be used for a long time and high output characteristics.

For example, Patent Literature 1 proposes lithium nickel-cobalt-aluminate in which the Li site occupancy of a Li site and the metal site occupancy of a metal site in a crystal are regulated, as a technique for increasing the output of a battery. However, a positive electrode active material described in Patent Literature 1 is insufficient to increase output and needs to be further improved.

Patent Literature 2 proposes that both high capacity and thermal stability are achieved in such a manner that primary particles with a composition represented by the formula LiNi_{1-x-y}CoₓE_{y}O₂ (where E is at least one selected from the group consisting of Mn, Al, and Ti; 0.10≦x≦0.20; and 0.02≦y≦0.10) are bonded to each other with oxides of Zr and Li and the differential thermogravimetric reduction of the particles heated to 750° C. in an inert atmosphere is regulated. However, there is no description of the increase of output in Patent Literature 2.

### CITATION LIST

### Patent Literature

PTL 1: Japanese Published Unexamined Patent Application No. 2008-218122
PTL 2: Japanese Published Unexamined Patent Application No. 11-219706

### SUMMARY OF INVENTION

### Technical Problem

The present invention provides a positive electrode active material, capable of achieving both high capacity and high output, for nonaqueous electrolyte secondary batteries and also provides a nonaqueous electrolyte secondary battery using the same.

### Solution to Problem

An embodiment of the present invention provides a positive electrode active material for nonaqueous electrolyte secondary batteries. The positive electrode active material contains a lithium transition metal oxide which has a layered structure and which contains Ni as a transition metal. The percentage of Ni element with respect to the total molar amount of metal elements, other than lithium, in the lithium transition metal oxide is 89 mole percent or more. A zirconium compound is present on the surface of the lithium transition metal oxide.

### Advantageous Effects of Invention

In accordance with a positive electrode active material for nonaqueous electrolyte secondary batteries according to an embodiment of the present invention, output characteristics can be enhanced with high capacity maintained.

### BRIEF DESCRIPTION OF DRAWINGS

FIG. 1 is a schematic view illustrating the schematic structure of a three-electrode test cell according to an embodiment of the present invention.

### DESCRIPTION OF EMBODIMENTS

A positive electrode active material for nonaqueous electrolyte secondary batteries according to an embodiment of the present invention and a nonaqueous electrolyte secondary battery are described below in detail using various experiment examples. The experiment, examples below are exemplified in order to illustrate an example of the positive electrode active material for nonaqueous electrolyte secondary batteries and an example of the nonaqueous electrolyte secondary battery for the purpose of embodying the technical spirit, of the present invention. It is not intended to limit the present invention to any of these experiment examples. The present invention is equally applicable to various modifications of those illustrated in these experiment examples without departing from the technical spirit described in the claims.

### First Experiment Example

### Experiment Example 1

### Preparation of Positive Electrode

To 100 g of lithium nickel-cobalt-aluminate represented by LiNi_{0.91}Co_{0.06}Al_{0.03}O₂, 0.64 g of zirconium oxide ZrO₂ (an average particle size of 1 μm) was added, followed by mixing, whereby lithium nickel-cobalt-aluminate was obtained, a zirconium compound being uniformly present on the surface of the. The amount of the zirconium compound was 0.5 mole percent of the total molar amount of metal elements, other than lithium, in the lithium nickel-cobalt-aluminate in terms of zirconium element.

Next, one part by mass of acetylene black serving as a carbon conductive agent and 0.9 parts by mass of polyvinylidene fluoride serving as a binder were mixed with 100 parts by mass of the positive electrode active material, followed by adding an adequate amount of NMP (N-methyl-2-pyrrolidone) to the mixture, whereby positive electrode slurry was prepared. Next, the positive electrode slurry was applied to both surfaces of a positive electrode current collector made of aluminium and was then dried. Finally, the positive electrode current collector was cut to a predetermined electrode size and was then rolled with a roller, followed by attaching a positive electrode lead to the positive electrode current collector, whereby a positive electrode was prepared.

### [Preparation of Three-Electrode Test Cell]

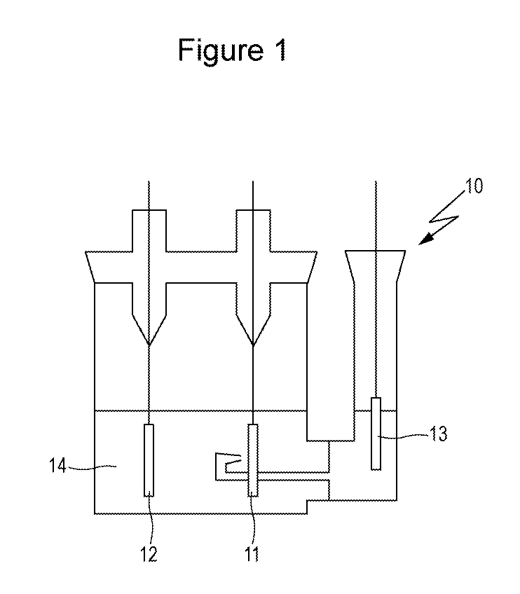

A three-electrode test cell 10 shown in FIG. 1 was prepared. In this operation, the positive electrode was used as a working electrode 11 and metallic lithium was used in a counter electrode 12 serving as a negative electrode and a reference electrode 13. A nonaqueous electrolyte solution 14 used was one that was prepared in such a manner that a solvent mixture was prepared by mixing ethylene carbonate, ethyl methyl carbonate, and dimethyl carbonate at a volume ratio of 30:30:40, LiPF₆ was dissolved in the solvent mixture such that the concentration of LiPF₆ was 1.0 per liter, and 1% by mass of vinylene carbonate was further dissolved. The cell prepared as described above is referred to as the battery of Experiment Example 1.

### Experiment Example 2

A cell was prepared in substantially the same manner as that used in Experiment Example 1 except that no Zr compound was present on the surface of the lithium nickel-cobalt-aluminate represented by LiNi_{0.91}Co_{0.06}Al_{0.03}O₂. The prepared cell is referred to as the battery of Experiment Example 2.

### Experiment Example 3

A cell was prepared in substantially the same manner as that used in Experiment Example 1 except that lithium nickel-cobalt-aluminate represented by LiNi_{0.89}Co_{0.08}Al_{0.03}O₂ used. The prepared cell is referred to as the battery of Experiment Example 3.

### Experiment Example 4

A cell was prepared in substantially the same manner as that used in Experiment Example 1 except that lithium nickel-cobalt-aluminate represented by LiNi_{0.89}Co_{0.08}Al_{0.03}O₂ used and no Zr compound was present on the surface of the lithium nickel-cobalt-aluminate. The prepared cell is referred to as the battery of Experiment Example 4.

### Experiment Example 5

A cell was prepared in substantially the same manner as that used in Experiment Example 1 except that lithium nickel-cobalt-aluminate represented by LiNi_{0.82}Co_{0.15}Al_{0.03}O₂ was used. The prepared cell is referred to as the battery of Experiment. Example 5.

### Experiment Example 6

A cell was prepared in substantially the same manner as that used in Experiment Example 1 except that lithium nickel-cobalt-aluminate represented by LiNi_{0.82}Co_{0.15}Al_{0.03}O₂ used and no Zr compound was present on the surface of the lithium nickel-cobalt-aluminate. The prepared cell, is referred to as the battery of Experiment Example 6.

### (Experiments)

### [Measurement of Rated Capacity]

The batteries of Experiment Examples 1 to 6 that were prepared as described above were charged to 4.3 V (vs. Li/Li⁺) at a temperature of 25° C. and a current density of 0.2 mA/cm² in a constant, current mode, were charged at a constant voltage of 4.3 V (vs. Li/Li⁺) in a constant voltage mode until the current, density reached 0.04 mA/cm², and were then discharged to 2.5 V (vs. Li/Li⁺) at a current density of 0.2 mA/cm² in a constant, current, mode. In this operation, the batteries of Experiment Examples 1 to 6 were measured for discharge capacity, whereby the rated capacity of each of the batteries of Experiment Examples 1 to 6 was determined. The relative value of the rated capacity of each of the batteries of Experiment Examples 1 to 5 was determined on the basis that the rated capacity of the battery of Experiment Example 6 was 100%. Results were shown in Table 1.

### [Measurement of Output]

Next, after the batteries of Experiment Examples 1 to 6 charged to 50% of the rated capacity (that is, until the state of charge SOC reached 50%) at a current density of 0.2 mA/cm², the batteries of Experiment Examples 1 to 6 were discharged at a current of 0.08 mA/cm² for 10 seconds, at a current of 0.4 mA/cm² for 10 seconds, at a current of 0.8 mA/cm² for 10 seconds, and at a current of 1.6 mA/cm² for 10 from the open circuit voltage. The voltage after 10 was plotted against current, whereby the current-voltage line of each of the batteries of Experiment Examples 1 to 6 was determined. The current Ip at a final voltage of 2.5 V was determined from the current-voltage line. The output at 25° C. was calculated from the following equation:

Output=Ip×2.5 (1).

The relative value of the output of each of the batteries of Experiment Examples 1, 3, and 5 was determined on the basis that the output of a corresponding one of the batteries of Experiment Examples 2, 4, and 6 was 100%, the composition of the lithium nickel-cobalt-aluminate used in each of Experiment Examples 2, 4, and 6 being the same as the composition of the lithium nickel-cobalt-aluminate used in a corresponding one of the batteries of Experiment Examples 1, 3, and 5, no Zr compound being present on the surface of the lithium nickel-cobalt-aluminate used in each of Experiment Examples 2, 4, and 6. Results were shown in Table 2.

TABLE 1

| | | | | | Relative |
|---|---|---|---|---|---|
| | Composition of lithium | | | | value of |
| | transition metal oxide | | | Zr compound | rated capacity |
| | Ni | Co | Al | (mole percent) | (%) |
| Experiment | 91 | 6 | 3 | 0.5 | 103.0 |
| Example 1 | | | | | |
| Experiment | 91 | 6 | 3 | 0 | 103.9 |
| Example 2 | | | | | |
| Experiment | 89 | 8 | 3 | 0.5 | 102.6 |
| Example 3 | | | | | |
| Experiment | 89 | 8 | 3 | 0 | 101.9 |
| Example 4 | | | | | |
| Experiment | 82 | 15 | 3 | 0.5 | 97.0 |
| Example 5 | | | | | |
| Experiment | 82 | 15 | 3 | 0 | 100.0 |
| Example 6 | | | | | |

TABLE 2

| | | | | | Relative value |
|---|---|---|---|---|---|
| | Composition of lithium | | | | of output |
| | transition metal oxide | | | Zr compound | (SOC 50%) |
| | Ni | Co | Al | (mole percent) | (%) |
| Experiment | 91 | 6 | 3 | 0.5 | 104 |
| Example 1 | | | | | |
| Experiment | 91 | 6 | 3 | 0 | 100 |
| Example 2 | | | | | |
| Experiment | 89 | 8 | 3 | 0.5 | 119 |
| Example 3 | | | | | |
| Experiment | 89 | 8 | 3 | 0 | 100 |
| Example 4 | | | | | |
| Experiment | 82 | 15 | 3 | 0.5 | 97 |
| Example 5 | | | | | |
| Experiment | 82 | 15 | 3 | 0 | 100 |
| Example 6 | | | | | |

As is clear from Table 1, when the Zr compound is present on the surface of lithium nickel-cobalt-aluminate, the batteries of Experiment Examples 1 and 3 that have a Ni element percentage of 89% or more have increased rated capacity as compared to the battery of Experiment Example 5 has a Ni element percentage of 82%. When no Zr compound is present on the surface of lithium nickel-cobalt-aluminate, the batteries of Experiment Examples 2 and 4 that have a Ni element percentage of 89% or more have increased rated capacity as compared to the battery of Experiment Example 6 that has a Ni element percentage of 82%. This shows that an increase in Ni element percentage increases rated capacity.

As is clear from Table 2, when the percentage of Ni element is 89% or more, the output of the batteries of Experiment Examples 1 and 3 that have the Zr compound present on the surface of lithium nickel-cobalt-aluminate is greater than the output of the batteries of Experiment Examples 2 and 4 that have no Zr compound present on the surface of lithium nickel-cobalt-aluminate. However, when the percentage of Ni element is 82% even though the Zr compound is present on the surface of lithium nickel-cobalt-aluminate as is the case with Experiment Examples 1 and 3, the output of the battery of Experiment Example 5 is less than the battery of Experiment Example 6 that has no Zr compound present on the surface of lithium nickel-cobalt-aluminate. This shows that the effect of increasing output is an effect obtained by the use of a lithium transition metal oxide having a Ni element percentage of 89% or more and a configuration in which the Zr compound is present on the surface of the lithium transition metal oxide.

The reason why these results were obtained is unclear and is probably as described below. When the amount of Li in a Li site ranges from 0.25 to 0.4, the crystal structure of the lithium transition metal oxide having a Ni element percentage of 89% or more transforms (phase transition) and therefore a monoclinic crystal and a hexagonal crystal are present. In the lithium transition metal oxide having a Ni element percentage of 89% or more, the phase transition occurs at a high potential, 4.15 V to 4.2 V. Therefore, when the Zr compound is present, on the surface of the lithium transition metal oxide, the Zr compound interacts with the nonaqueous electrolyte solution to form a good coating having high ion permeability on the surface of the lithium transition metal oxide. This results in an increase in output. However, when Zr is not present, a formed coating has low ion permeability. This coating acts as a resistor and therefore causes a reduction in output. When the percentage of Ni element, is less than 89%, phase transition does not occur or the potential of a phase transition region is low, less than 4.15 V, and therefore a good coating having high ion permeability cannot be formed. Thus, the use of the lithium transition metal oxide having a Ni element, percentage of 89% or more and the presence of the Zr compound on the surface of the lithium transition metal oxide enable both high capacity and high output to be achieved.

In Experiment Examples 1, 3, and 5, the case where the lithium transition metal oxide is lithium nickel-cobalt-aluminate is described. The lithium transition metal oxide may have a Ni element percentage of 89% or more and has a similar effect. In the present invention, the expression “the percentage of Ni element is 89% or more” means that the percentage of Ni element with respect to the total molar amount of metal elements, other than lithium, in the lithium transition metal oxide is 89 mole percent or more.

The increase in percentage of Ni increases the reduction of output due to the structural deterioration of an active material in association with charge and discharge and therefore an effect of the above good coating is not sufficiently obtained. Therefore, the percentage of Ni element is preferably 89% to 98%, more preferably 89% to 95%, and further more preferably 89% to 91%.

### Second Experiment Example

### Experiment Example 7

### Synthesis of Positive Electrode Active Material

Lithium hydroxide was mixed with 100 g of a nickel-cobalt-aluminium composite oxide represented by Ni_{0.89}Co_{0.08}Al_{0.03}O₂ suck that lithium element accounted for 1.025 with respect to the total molar amount of metal elements, other than lithium, in the nickel-cobalt-aluminium composite oxide. Furthermore, zirconium oxide was mixed with the nickel-cobalt-aluminium composite oxide such that zirconium accounted for 0.5 mole percent of total molar amount of metal elements, other than lithium, in the nickel-cobalt-aluminium composite oxide. After mixing, the mixture was fired for 18 hours in an oxygen atmosphere, whereby lithium nickel-cobalt-aluminate represented by LiNi_{0.89}Co_{0.08}Al_{0.03}O₂ was obtained, a zirconium compound being present on the surface of the lithium nickel-cobalt-aluminate.

### [Preparation of Three-Electrode Test Cell]

A three-electrode test cell was prepared in the same manner as that used in Experiment Example 1 except that a positive electrode active material obtained as described above was used and a nonaqueous electrolyte solution used was one prepared in such a manner that a solvent mixture was prepared by mixing ethylene carbonate, ethyl methyl carbonate, and dimethyl carbonate at a volume ratio of 30:30:40, LiPF₆ was dissolved in the solvent mixture such that the concentration of LiPF₆ was 1.0 mole per liter, and 1% by mass of vinylene carbonate and 0.5% by mass of adiponitrile were further dissolved. The cell prepared as described above is referred to as the battery of Experiment Example 7.

### Experiment Example 8

A cell was prepared in the same manner as that used in Experiment Example 7 except that no adiponitrile was dissolved in a nonaqueous electrolyte solution. The prepared cell is referred to as the battery of Experiment Example 8.

### Experiment Example 3

A cell was prepared in the same manner as that used in Experiment Example 7 except that no Zr compound was present on the surface of the lithium nickel-cobalt-aluminate represented by LiNi_{0.89}Co_{0.08}Al_{0.03}O₂. The prepared cell is referred to as the battery of Experiment Example 9.

### Experiment Example 10

A cell was prepared in the same manner as that used in Experiment Example 7 except that no Zr compound was present on the surface of the lithium nickel-cobalt-aluminate represented by LiNi_{0.89}Co_{0.08}Al_{0.03}O₂ and no adiponitrile was dissolved in a nonaqueous electrolyte solution. The prepared cell is referred to as the battery of Experiment Example 10.

### (Experiments)

The batteries of Experiment Examples 7 to 10 that were prepared as described above were charged to 4.3 V (vs. Li/Li⁺) at a temperature of 25° C. and a current density of 0.2 mA/cm² in a constant current mode, were charged at a constant voltage of 4.3 V (vs. Li/Li⁺) in a constant voltage mode until the current density reached 0.04 mA/cm², and were then discharged to 2.5 V (vs. Li/Li⁺) at a current, density of 0.2 mA/cm² in a constant current mode.

### [Measurement of Resistance]

After the batteries of Experiment Examples 7 to 10 were charged to 4.3 V (vs. Li/Li⁺) at a temperature of 25° C. and a current, density of 0.2 mA/cm² in a constant current mode and were charged at a constant, voltage of 4.3 V (vs. Li/Li⁺) in a constant voltage mode until the current density reached 0.04 mA/cm², the batteries of Experiment Examples 7 to 10 discharged at a current density of 0.2 mA/cm². The resistance was calculated from the potential measured 0.1 after the start, of discharge and the potential measured just before the start, of discharge using the following equation:

Resistance=(potential measured just before start of discharge−potential measured 0.1 seconds after start of discharge)/(current density during discharge×electrode area) (2).

The resistance of each of the batteries of Experiment Examples 7 to 10 was shown as a relative value determined on the basis that the resistance of the battery of Experiment Example 10 was 100%. Results are shown in Table 3.

TABLE 3

| | Composition of | | | Zr | | Relative |
|---|---|---|---|---|---|---|
| | lithium transition | | | compound | | value of |
| | metal oxide | | | (mole | Nitrile | resistance |
| | Ni | Co | Al | percent) | compound | (%) |
| Experiment | 89 | 8 | 3 | 0.5 | Adiponitrile | 97 |
| Example 7 | | | | | | |
| Experiment | 89 | 8 | 3 | 0.5 | Not added | 98 |
| Example 8 | | | | | | |
| Experiment | 89 | 8 | 3 | 0 | Adiponitrile | 121 |
| Example 9 | | | | | | |
| Experiment | 89 | 8 | 3 | 0 | Not added | 100 |
| Example 10 | | | | | | |

As is clear from Table 3, Experiment Examples 7 and 8 have the Zr compound present on the surface of the lithium transition metal oxide having a Ni element percentage of 89% or more have lower resistance as compared to Experiment Examples 9 and 10 and therefore are excellent output characteristics. Experiment Example 8 that has the Zr compound present on the surface of a lithium transition metal oxide and no added adiponitrile has reduced resistance as compared to Experiment Example 10 that has none of the Zr compound and adiponitrile. Experiment Example 9 that has no Zr compound, present on the surface of a lithium transition metal oxide and added adiponitrile has significantly increased resistance as compared to Experiment Example 10 has none of the Zr compound and adiponitrile. However, the battery of Experiment Example 7 that has both the Zr compound and adiponitrile has reduced resistance as compared to Experiment Example 8 that has the Zr compound only. This shows that high output can be achieved in such a manner that the positive electrode active material in which the Zr compound is present on the surface of the lithium transition metal oxide having a Ni element percentage of 89% or more is used and the nonaqueous electrolyte solution containing an adiponitrile compound is used.

When no Zr compound is present on the surface of the lithium transition metal oxide, the battery of Experiment Example 9 that contains the nonaqueous electrolyte solution containing adiponitrile has significantly increased resistance as compared to the battery of Experiment Example 10 that contains no adiponitrile. However, when the Zr compound is present on the surface of the lithium transition metal oxide, the battery of Experiment Example 7 that contains the nonaqueous electrolyte solution containing adiponitrile has reduced resistance as compared to the battery of Experiment Example 8 that contains no adiponitrile. This shows that the effect of reducing resistance by the addition of adiponitrile is an effect specific to the case where the lithium transition metal oxide having a Ni element percentage of 89% or more is used and the Zr compound is present on the surface of the lithium transition metal oxide.

The reason why these results were obtained is unclear and is probably as described below. In a phase transition region induced at 4.15 V to 4.2 V in the lithium transition metal oxide having a Ni element percentage of 89% or more, a CN bond of a nitrile compound present in a nonaqueous electrolyte solution probably reacts with zirconium present on the surface of the lithium transition metal oxide to form a good coating having electron conductivity and ion permeability. Thus, in a nonaqueous electrolyte secondary battery using a lithium transition metal oxide having a configuration of the present invention, a nonaqueous electrolyte solution preferably contains a nitrile compound.

In Experiment Example 7, the case where a nitrile compound is adiponitrile is described. The nitrile compound may contain a CN bond. The number of carbon atoms in the nitrile compound is not particularly limited. Such nitrile compounds have a similar effect. The nitrile compound is preferably a dinitrile compound and is more preferably adiponitrile, succinonitrile, pimelonitrile, or the like.

In an embodiment of the present invention, a zirconium compound is preferably present on the surface of a lithium transition metal oxide represented by the formula LiₐNiₓM₁₋ₓO₂ 0.9≦a≦1.2; 0.89≦x; and M is at least one selected from the group consisting of Co, Mn, and Al). It is preferable that 0.89≦x≦1. It is more preferable that 0.89≦x≦0.98. It is further more preferable that 0.89≦x≦0.95. It is still further more preferable that 0.89≦x≦0.91.

The zirconium compound may be present on the surface of the lithium transition metal oxide. The state of the zirconium compound is not particularly limited. Therefore, the zirconium compound may be an oxide, a hydroxide, a sulfide, a sulfate, a nitride, a nitrate, a chloride, a silicide, a silicate, a tungstate, a phosphate, or a carbonate. Examples of the zirconium compound include ZrO₂, Zr(OH)₂, ZrS₂, Zr(SO₄)₂.4H₂O, ZrN, Zr(NO₃)₂O.2H₂O, ZrCl₃, ZrCl₄, ZrSi₂, ZrSiO₄, Zr(WO₄)₂, ZrO(H₂PO₄)₂.nH₂O, ZrOCO₃, and ZrO₂.nH₂O. The state of Zr may be an organic salt. Examples of the organic salt include Zr(C₁₁H₂₃COO)₂O, Zr(OC₃H₇)₄, and Zr(OC₄H₉)₄.

Particles of the zirconium compound preferably have an average size of 1 nm to 5,000 nm. When the average size of the zirconium compound particles is more than 5,000 nm, the size of the zirconium compound particles is extremely larger than the size of particles of the lithium transition metal oxide; hence, the surface of each lithium transition metal oxide particle is not densely covered with the zirconium compound. Thus, the area of direct contact between the lithium transition metal oxide particle and a nonaqueous electrolyte solution is large. Therefore, a coating with high ion permeability cannot be formed and output characteristics are low.

However, when the average size of the zirconium compound particles is less than 1 nm, the surface of each lithium transition metal oxide particle is extremely densely covered with the zirconium compound. Therefore, the storage and release of lithium ions on the surface of the lithium transition metal oxide particle is low and output characteristics are low. In consideration of these things, the average size of the zirconium compound particles is preferably 10 nm to 3,000 nm.

A method for allowing the zirconium to be present on the surface of the lithium transition metal oxide is not particularly limited. Examples of the method include a method in which the zirconium compound, a lithium compound, and transition metal oxides are mixed together and are fired; a method in which an aqueous solution containing a zirconium salt dissolved therein is mixed with a solution containing the lithium transition metal oxide dispersed therein; and a method in which the zirconium compound is used to prepare positive electrode slurry. In consideration of a process aspect, the following methods are preferable: the method in which the zirconium compound, the lithium compound, and the transition metal oxides are mixed together and are fired and the method in which the zirconium compound is used to prepare the positive electrode slurry.

The percentage of zirconium element with respect to the total molar amount of metals, other than lithium, in the lithium transition metal oxide is preferably 0.001 mole percent to 2.0 mole percent. When the percentage thereof is less than 0.001 mole percent, an effect of zirconium present on the surface of the lithium transition metal oxide is not sufficiently exhibited in some cases. However, when the percentage thereof is more than 2.0 mole percent, the lithium ion permeability of the surface of each lithium transition metal oxide particle is low and output characteristics are low in some cases.

The lithium transition metal oxide may contain at least one selected from the group consisting of magnesium, aluminium, titanium, chromium, vanadium, iron, copper, zinc, niobium, molybdenum, zirconium, tin, tungsten, sodium, and lithium. In particular, the lithium transition metal oxide preferably contains aluminium. Preferable examples of the lithium transition metal oxide include LiNi_{0.9}Co_{0.1}O₂, LiNi_{0.9}Mn_{0.1}O₂, LiNi_{0.9}C_{0.05}Mn_{0.05}O₂, and LiNi_{0.90}Co_{0.05}Al_{0.05}O₂. More preferable examples of the lithium transition metal oxide include lithium nickel-cobalt-manganate and lithium nickel-cobalt-aluminate. In the lithium transition metal oxide, oxygen may be partly substituted by fluorine.

The lithium oxide is preferably one represented by the formula LiₐNiₓCo_{y}Al_{z}O₂ (where 0.9≦a≦1.2, 0.89≦x≦1, 0<y+ z≦0.11, 0< y, and 0< z). It is more preferable that 0.89≦x≦0.98. It is further more preferable that 0.89≦x≦0.95. It is still further more preferable that 0.89≦x≦0.91.

### (Other Items)

(1) A solvent for a nonaqueous electrolyte solution is not particularly limited. A solvent conventionally used in nonaqueous electrolyte secondary batteries can be used. The following compounds can be used: for example, cyclic carbonates such as ethylene carbonate, propylene carbonate, butylene carbonate, and vinylene carbonate; linear carbonates such as dimethyl carbonate, ethyl methyl carbonate, and diethyl carbonate; compounds including esters such as methyl acetate, ethyl acetate, propyl acetate, methyl propionate, ethyl propionate, and γ-butyrolactone; sulfo group-containing compounds such as propanesultone; compounds including ethers such as 1,2-dimethoxyethane, 1,2-diethoxyethane, tetrahydrofuran, 1,2-dioxane, 1,4-dioxane, and 2-methyltetrahydrofuran; compounds including nitriles such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; compounds including amides such as dimethylformamide; and the like. In particular, a solvent in which H is partly substituted by F is preferably used. These may be used alone or in combination. The following solvent is particularly preferable: a solvent which is a combination of a cyclic carbonate and a linear carbonate or a solvent which is a combination of these carbonates and small amounts of compounds including nitriles or compounds including ethers.

An ionic liquid can be used as a nonaqueous solvent for the nonaqueous electrolyte solution. In this case, a cationic species and an anionic species are not particularly limited. A combination of a cation such as a pyridinium cation, an imidazolium cation, or a quaternary ammonium cation and an anion such as a fluorine-containing imide anion is particularly preferable from the viewpoint of low viscosity, electrochemical stability, and hydrophobicity.

Furthermore, as a solute for the nonaqueous electrolyte, a known lithium salt conventionally used in nonaqueous electrolyte secondary batteries can be used. The lithium salt used may be one containing at least one selected from the group consisting of P, B, F, O, S, N, and Cl. Usable examples of the lithium salt include lithium salts such as LiPF₆, LiBF₄, LiCF₃SO₃, LiN(FSO₂)₂, LiN(CF₂SO₂)₂, LiN(C₂F₅SO₂)₂, LiN(CF₃SO₂)(C₄F₉SO₂), LiC(C₂F₅SO₂)₃, LiAsF₆, and LiClO₄ and mixtures of these salts. In particular, LiPF₆ is preferably used in order to enhance high-rate charge/discharge characteristics.

The solute used may be a lithium salt containing an oxalato complex anion. Usable examples of the oxalato complex anion-containing lithium salt include LiBOB (lithium bis(oxalate)borate) and lithium salts, containing an anion containing C₂O₄²⁻ coordinated to a central atom, represented by, for example, Li[M(C₂O₄)ₓR_{y}] (where M is a transition metal or an element selected from Group IIIb, Group IVb, and Group Vb in the periodic table; R is a halogen or a group selected from an alkyl group and a halogen-substituted alkyl group; x is a positive integer; and y is 0 or a positive integer). In particular, the solute is Li[P(C₂O₄)₃] or the like. However, in order to form a stable coating on a surface of a negative electrode in high-temperature environments, the use of LiBOB is most preferable. Incidentally, the solute may be used alone or in combination with another solute. The concentration of the solute is not particularly limited and is preferably 0.8 moles to 1.7 per liter of the nonaqueous electrolyte solution. Furthermore, for applications needing large-current discharge, the concentration of the solute is preferably 1.0 to 1.7 moles per liter of the nonaqueous electrolyte solution.

(2) A negative electrode active material is not particularly limited and may be capable of reversibly storing and releasing lithium. For example, a carbon material, a metal or alloy material capable of being alloyed with lithium, a metal oxide, or the like can be used. From the viewpoint of material costs, the negative electrode active material used is preferably the carbon material. For example, natural graphite, synthetic graphite, mesophase pitch-based carbon fibers (MCFs), meso-carbon microbeads (MCMBs), coke, hard carbon, or the like can be used. In particular, from the viewpoint of enhancing high-rate charge/discharge characteristics, the negative electrode active material used is preferably a carbon material prepared by coating a graphitic material with low-crystallinity carbon.

(3) A separator used may be one conventionally used. In particular, a separator made of polyethylene, a separator including a polypropylene layer formed on polyethylene, or a polyethylene separator surface-coated with an aramid resin or the like may be used.

(4) A layer containing inorganic filler conventionally used may be formed between the separator and a positive electrode or a negative electrode. The filler used may be an oxide, containing one or some of titanium, aluminium, silicon, and magnesium, conventionally used; a phosphoric acid compound, containing one or some of titanium, aluminium, silicon, and magnesium, conventionally used; or one surface-treated with a hydroxide or the like. The filler layer can be formed in such a manner that filler-containing slurry is directly applied to the positive electrode, the negative electrode, or the separator; in such a manner that a sheet formed from the filler is attached to the positive electrode, the negative electrode, or the separator; or in another manner.

### INDUSTRIAL APPLICABILITY

An embodiment of the present invention can be expected to be applied to, for example, driving power supplies for mobile data terminals such as mobile phones, notebook personal computers, and smartphones; driving power supplies for high-power applications such as electric vehicles, HEVs, and electric tools; and power supplies associated with power storage.

### REFERENCE SIGNS LIST

10 Three-electrode test cell
11 Working electrode
12 Counter electrode
13 Reference electrode
14 Nonaqueous electrolyte solution

1-6. (canceled)

7. A nonaqueous electrolyte secondary battery comprising,
a positive electrode containing a positive electrode active material,
a negative electrode, and
a nonaqueous electrolyte solution containing adiponitrile,
wherein the positive electrode active material containing a lithium transition metal oxide which has a layered structure and which contains Ni as a transition metal, wherein the percentage of Ni with respect to the total molar amount of metal elements, other than lithium, in the lithium transition metal oxide is 89 mole percent or more and a zirconium compound is present on the surface of the lithium transition metal oxide.

8. The nonaqueous electrolyte secondary batteries according to claim 7, wherein the lithium transition metal oxide is represented by the formula LiₐNiₓM₁₋ₓO₂ (where 0.9≦a≦1.2; 0.89≦x; and M is at least one selected from the group consisting of Co, Mn and Al).

9. The nonaqueous electrolyte secondary batteries according to claim 7, wherein the zirconium compound is zirconium oxide.

10. The nonaqueous electrolyte secondary batteries according to claim 7, wherein the phase transition of the lithium transition metal oxide occurs at a potential of 4.15 V (vs Li/Li+) or more.
